(19) United States
(12) Patent Application Publication
(10) Pub. No.: US 2022/0275200 A1
(43) Pub. Date: Sep. 1, 2022

(54) COMPOSITE POLYMER PALLET COMPONENTS

(71) Applicant: NIAGARA BOTTLING, LLC, Diamond Bar, CA (US)

(72) Inventors: Jay Clarke Hanan, Glendora, CA (US); Sudheer Bandla, Rancho Cucamonga, CA (US)

(21) Appl. No.: 17/774,415

(22) PCT Filed: Nov. 2, 2020
(86) PCT No.: PCT/US20/58561

§ 371 Date: May 4, 2022

Related U.S. Application Data
(60) Provisional application No. 62/930,085, filed on Nov. 4, 2019.

(51) Int. Cl. C08L 67/03; C08L 23/06; C08L 23/12; B65D 19/00

(52) U.S. Cl. CPC C08L 67/03; C08L 23/06; C08L 23/12; B65D 19/0095; B65D 2519/00029; B65D 2519/00034; B65D 2519/00039; B65D 2519/00064; B65D 2519/00069; B65D 2519/00074; B65D 2519/00099; B65D 2519/00104; B65D 2519/00109; B65D 2519/00273; B65D 2519/00293; B65D 2519/00323; B65D 2519/00333; B65D 2519/00562

(57) ABSTRACT

Disclosed herein are embodiments of pallets and pallet components which can be formed from composite materials, such as composite polymer materials. The composites can include polymer-polymer composites as well as wood-polymer composites. Advantageously, the composite pallet components can be formed from recycled plastics, such as polypropylene and polyethylene, which can be acquired from used bottles.

### CROSS-REFERENCE

This application claims the benefit of U.S. Provisional Patent Application No. 62/930,085, filed Nov. 4, 2019, the entirety of which is hereby incorporated by reference.

### BACKGROUND

### Field

Embodiments of the disclosure generally relate to composite polymer materials that may be useful as pallet components, pallets made from composite polymer materials, and methods of making such pallets.

### SUMMARY

Disclosed herein are embodiments of a composite polymer deckboard component comprising a polymer matrix selected from the group consisting of polypropylene, polyethylene, polyethylene terephthalate, and combinations thereof, wherein the composite polymer deckboard is shaped to replace a wooden deckboard on a pallet.

In some embodiments, the polymer matrix comprises only polypropylene. In some embodiments, the polymer matrix comprises only polyethylene. In some embodiments, the polymer matrix comprises only polyethylene terephthalate. In some embodiments, the component can further comprise graphene or graphene nano-platelets. In some embodiments, the polymer matrix comprises about 95% polyethylene with about 5% polypropylene. In some embodiments, the polymer matrix comprises about 10% polyethylene and/or about 2% polypropylene with the remainder being polyethylene terephthalate.

In some embodiments, wherein the component further includes a plurality of fibers embedded into the polymer matrix. In some embodiments, the plurality of fibers are selected from the group consisting of polyethylene terephthalate, polypropylene, jute, e-glass, wood, switchgrass, natural fibers and combinations thereof. In some embodiments, the plurality of fibers are plasma treated.

Also disclosed herein are embodiments of a method of forming a composite polymer pallet component, the method comprising providing recycled polymer material selected from the group consisting of polypropylene, polyethylene, polyethylene terephthalate, and combinations thereof, forming a polymer matrix form the recycled polymer material, and forming a pallet component from the polymer matrix.

In some embodiments, the recycled polymer material comes from recycled plastic bottles. In some embodiments, voids are intentionally introduced into the polymer matrix to lower density.

In some embodiments, the method can further comprise providing recycled fiber material and embedding the recycled fiber material within the polymer matrix to form a composite material.

In some embodiments, the recycled fiber material comes from recycled carpet. In some embodiments, the composite material is formed by over-molding. In some embodiments, the composite material is formed by compression molding. In some embodiments, the recycled polymer material and/or the recycled fiber material is processed after the collecting by at least one of cleaning, cutting, or grinding. In some embodiments, the method can further comprise plasma treating the recycled fiber material.

In some embodiments, the polymer matrix comprises only polypropylene. In some embodiments, the polymer matrix comprises only polyethylene. In some embodiments, the polymer matrix comprises only polyethylene terephthalate. In some embodiments, the composite material can further comprise graphene or graphene nano-platelets. In some embodiments, the polymer matrix comprises about 95% polyethylene with about 5% polypropylene. In some embodiments, the polymer matrix comprises about 10% polyethylene and/or about 2% polypropylene with the remainder being polyethylene terephthalate.

Also disclosed herein are embodiments of a pallet comprising a plurality of bottom boards extending in a first direction, each of the plurality of bottom boards having a first end, a middle, and a second end, a plurality of top boards extending in the first direction, each of the plurality of top boards having a first end, a middle end, and a second end, and a plurality of connecting boards extending in a second direction generally transverse to the first direction, a first of the plurality of connecting boards attaching the first ends of the plurality of bottom boards to the first ends of the plurality of top boards, a second of the plurality of connecting boards attaching the middles of the plurality of bottom boards to the middles of the plurality of top boards, and a third of the plurality of connecting boards attaching the second ends of the plurality of bottom boards to the second ends of the plurality of top boards, wherein the plurality of top boards comprises a polymer matrix selected from the group consisting of polypropylene, polyethylene, polyethylene terephthalate, or combinations thereof.

In some embodiments, the polymer matrix comprises only polypropylene. In some embodiments, the polymer matrix comprises only polyethylene. In some embodiments, the polymer matrix comprises only polyethylene terephthalate. In some embodiments, the pallet can further comprise graphene or graphene nano-platelets. In some embodiments, the polymer matrix comprises about 95% polyethylene with about 5% polypropylene. In some embodiments, the polymer matrix comprises about 10% polyethylene and/or about 2% polypropylene with the remainder being polyethylene terephthalate.

In some embodiments, the pallet further includes a plurality of fibers embedded into the polymer matrix. In some embodiments, the plurality of fibers are selected from the group consisting of polyethylene terephthalate, polypropylene, jute, e-glass, wood, switchgrass, natural fibers and combinations thereof. In some embodiments, the plurality of fibers are plasma treated.

### BRIEF DESCRIPTION OF THE DRAWINGS

FIG. 1 illustrates an embodiment of a pallet construction.

FIG. 2A illustrates a pallet with a top deck board replaced with a composite of the disclosure.

FIG. 2B illustrates a pallet with a single top deck board replaced with a composite of the disclosure.

FIG. 3A illustrates maximum compression stress on 3.5″ outer deck boards.

FIG. 3B illustrates maximum compression stress on 5.5″ outer deck boards.

FIG. 4 illustrates an FTIR spectrum of a sample.

FIGS. 5A-5B illustrate a pallet.

### DETAILED DESCRIPTION

Disclosed herein are embodiments of composite pallet components used to make pallets, for example plastic-plastic composites or wood-plastic composites, which have a number of significant advantages over wood pallet components. Using composite materials instead of wood may eliminate most of the issues that arise from current pallets. For example, swelling from humidity may be minimized or eliminated. Repair due to wear and tear may be unchanged, as the same tools used to repair wood pallets may also be used to repair composite pallets. Specifically, since the composite components can be made to match the size of the wood components, each component can be replaced when damaged rather than replacing the entire pallet. Advantageously, embodiments of the composite material can have physical properties, such as specific strength, modulus, density, and creep resistance, close to that of wood. This could advantageously prevent the composite from being too heavy, which may cause issues in the pallet. Further, the pallet components can be made in the same general shape as a wood pallet so that each piece of the pallet can be replace with a composite component as disclosed herein, rather than the whole pallet.

### Pallet Design

The dimensions of modern pallets (e.g., 40″×48″) are based on a size that fits in a cart pulled by a horse. Refinements in geometry have been made for both utility and cost reasons. New standards have been considered and have been adopted in some countries. There are now two primary pallets that are common for the transportation and warehousing of heavy goods. One called the Stringer pallet is characterized not only by the wood color, but also some cuts into the stringers that allow side access to the pallet from a fork. The Stringer pallets are made out of wood and as they are often recycled for multiple uses can be damaged. Due to their design this damage is often more severe than the other types of pallets. Another pallet type is known as the Block pallet. The Block pallet has better performance due in part to the location of cross members in the structure as well as the design avoids cutting into the wood components, which would otherwise weaken the structure. A third type of pallet is a high density polyethylene (HDPE) pallet. Some of the properties of the pallets can be found in the below Table 1.

TABLE 1
Properties of different pallets

| Pallet | Type | Material |
|---|---|---|
| Block | Stringer | Wood |
| | Partial 4-way | |
| Stringer | Block | Wood (painted |
| | 4-way | blue) |
| HDPE | Block | HDPE plastic |
| | 4-way | |

Even though their performance is generally acceptable, wood pallets have several known issues. One major issue is that they absorb moisture from the air, so that the predicted weight of product on a truck can be off enough to put the trailer overweight in some states. Another one is chipping due to normal or excessive wear which leaves unwanted organic debris in a food manufacturing facility. Wood has a tendency to harbor many forms of life from microscopic up to and including insects and rodents. An industry has grown up that attempts to kill any organisms in wood pallets. Such treated pallets are required by some customers. This is very common for over ocean shipping.

Over the last decade, several manufacturers have sought to replace wood pallets with plastic pallets. There are many varieties and new types are introduced every year. A majority of these are not successful in competing with wood pallets. They either cannot hold the weight or are themselves too heavy and expensive.

A typical polymer used for plastic pallets is polyethylene (PE). Often fillers are used and the recycled content is high. Steel reinforcement is also often necessary, and even then, creep deformation is an issue plaguing most designs. While it is advantageous that a plastic pallet does not chip as much when damaged during use, and has a more constant weight than wood, if the damage is not superficial, a plastic pallet must be replaced or at least sent to an advanced facility for repair. Most often repair is difficult and it is easier to grind it in order to be recycled.

### Composite Polymer Pallet Components

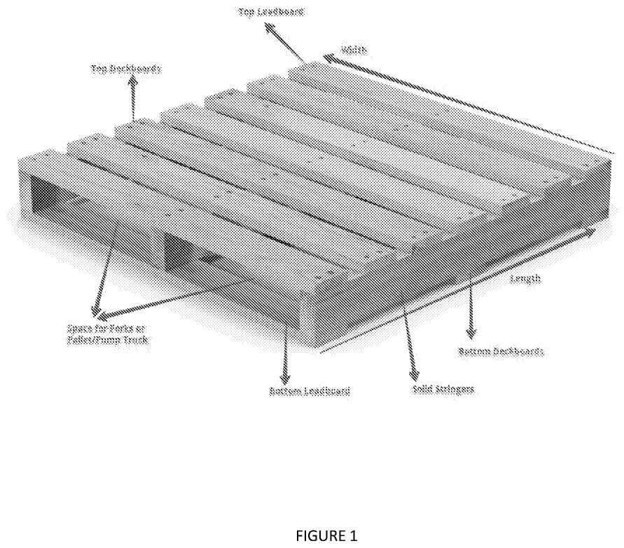

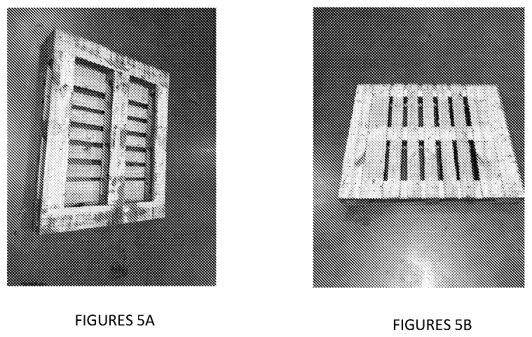

FIGS. 1 and 5A-5B illustrates one embodiment of a wooden pallet comprising wooden components, such as top deckboards, a top leadboard, solid stringers, bottom deckboards and a bottom leadboard. In some embodiments, wood components, or other plastic components, of pallets can be replaced with composite panels, planks or boards as disclosed herein. This could apply to any pallet structures, and is not limited to just the top deckboards as shown in FIGS. 1 and 5A-5B. For example, other components, such as the bottom deckboards and/or solid stringers can be replaced with embodiments of the disclosed composite materials.

In some embodiments, discarded material from a recycled polyethylene terephthalate (rPET) process can be incorporated into composite components for a pallet. For example, recycled components from plastic bottles can be used for the formation of the composite pallet components. In some embodiments, high density polyethylene (HDPE) from closures, such a bottle caps and the like, and polypropylene (PP) from labels or caps can be used as matrix materials for the composite.

Other components/materials can be used for load reinforced composite panels. For example, the pallet components may include steel bars for strength, and the composite planks may include a channel to receive such bars. Further, graphene can be incorporated into the composite material to provide further strength. For example, the graphene can be melted into any of the polymer components. In some embodiments, the graphene can be added using a powder mix or in-situ polymerization method. In some embodiments, the composite panels can be made from recycled wood and recycled plastic, as opposed to virgin petroleum based plastic and virgin wood. Using the recycled materials can advantageously reduce the manufacturing carbon footprint and be more eco-friendly.

In some embodiments, once a wooden top deck board is damaged beyond use, it could be replaced with composite deck boards having improved properties over the wood board.

### Materials

As mentioned above, pallet components such as pallet panels, planks or boards can be formed from composite materials. This can include polymer-polymer composites, wood-polymer composites, or other composite materials not limiting to the disclosure.

Typically, composites are formed by two or more constituent materials with significantly different physical or chemical properties. When combined, a material is produced with properties different from the constitute materials. In some embodiments, the individual components may remain separate and distinct, as opposed to mixtures or alloys. In particular, fiber reinforced composites can be advantageous for pallet components. The pallet components may have a polymer matrix in which optional fibers (e.g., reinforcements) of other materials, such as polymers, woods, natural fibers, etc., can be embedded into the matrix. In some embodiments, the fibers may be long and extend a length of the matrix. In some embodiments, the fibers may be shorter and a great number may be included in the matrix. The fibers may be aligned in a single direction, or may have differing orientations (for example, orthogonal directions or generally random directions). The orientation of the fibers within the matrix can provide different physical properties to the composite.

In some embodiments, the composite pallet component as disclosed herein may include fibers. In some embodiments, fibers are not included.

Non-limiting examples of polymers that can be used for the matrix or the reinforcement are polyethylene (PE), polypropylene (PP), and polyethylene terephthalate (PET). As used herein, polyethylene can include high density polyethylene or low density polyethylene (LDPE). Polyethylene and polypropylene polymers can come from recycled materials, such as bottles. For example, the polyethylene can be taken from recycled high density polyethylene (HDPE) caps, and the polypropylene can come be taken from recycled bottle labels or recycled (PP) caps. The amount of polyethylene, polyethylene terephthalate, and polypropylene in the matrix can range from approximately 0 to 100% polyethylene and 0 to 100% polypropylene and all mixtures in between.

In some embodiments, the composite matrix can be 5, 10, 15, 20, 25, 30, 35, 40, 45, 50, 55, 60, 65, 70, 75, 80, 85, 90, or 95 wt. % (or about 5, about 10, about 15, about 20, about 25, about 30, about 35, about 40, about 45, about 50, about 55, about 60, about 65, about 70, about 75, about 80, about 85, about 90, or about 95) polyethylene. In some embodiments, the composite matrix can be greater than 5, 10, 15, 20, 25, 30, 35, 40, 45, 50, 55, 60, 65, 70, 75, 80, 85, 90, or 95 wt. % (or greater than about 5, about 10, about 15, about 20, about 25, about 30, about 35, about 40, about 45, about 50, about 55, about 60, about 65, about 70, about 75, about 80, about 85, about 90, or about 95) polyethylene. In some embodiments, the composite matrix can be less than 5, 10, 15, 20, 25, 30, 35, 40, 45, 50, 55, 60, 65, 70, 75, 80, 85, 90, or 95 wt. % (or less than about 5, about 10, about 15, about 20, about 25, about 30, about 35, about 40, about 45, about 50, about 55, about 60, about 65, about 70, about 75, about 80, about 85, about 90, or about 95) polyethylene.

In some embodiments, the composite matrix can be 5, 10, 15, 20, 25, 30, 35, 40, 45, 50, 55, 60, 65, 70, 75, 80, 85, 90, or 95 wt. % (or about 5, about 10, about 15, about 20, about 25, about 30, about 35, about 40, about 45, about 50, about 55, about 60, about 65, about 70, about 75, about 80, about 85, about 90, or about 95) polypropylene. In some embodiments, the composite matrix can be greater than 5, 10, 15, 20, 25, 30, 35, 40, 45, 50, 55, 60, 65, 70, 75, 80, 85, 90, or 95 wt. % (or greater than about 5, about 10, about 15, about 20, about 25, about 30, about 35, about 40, about 45, about 50, about 55, about 60, about 65, about 70, about 75, about 80, about 85, about 90, or about 95) polypropylene. In some embodiments, the composite matrix can be less than 5, 10, 15, 20, 25, 30, 35, 40, 45, 50, 55, 60, 65, 70, 75, 80, 85, 90, or 95 wt. % (or less than about 5, about 10, about 15, about 20, about 25, about 30, about 35, about 40, about 45, about 50, about 55, about 60, about 65, about 70, about 75, about 80, about 85, about 90, or about 95) polypropylene.

In some embodiments, the composite matrix can be 5, 10, 15, 20, 25, 30, 35, 40, 45, 50, 55, 60, 65, 70, 75, 80, 85, 90, or 95 wt. % (or about 5, about 10, about 15, about 20, about 25, about 30, about 35, about 40, about 45, about 50, about 55, about 60, about 65, about 70, about 75, about 80, about 85, about 90, or about 95) polyethylene terephthalate. In some embodiments, the composite matrix can be greater than 5, 10, 15, 20, 25, 30, 35, 40, 45, 50, 55, 60, 65, 70, 75, 80, 85, 90, or 95 wt. % (or greater than about 5, about 10, about 15, about 20, about 25, about 30, about 35, about 40, about 45, about 50, about 55, about 60, about 65, about 70, about 75, about 80, about 85, about 90, or about 95) polyethylene terephthalate. In some embodiments, the composite matrix can be less than 5, 10, 15, 20, 25, 30, 35, 40, 45, 50, 55, 60, 65, 70, 75, 80, 85, 90, or 95 wt. % (or less than about 5, about 10, about 15, about 20, about 25, about 30, about 35, about 40, about 45, about 50, about 55, about 60, about 65, about 70, about 75, about 80, about 85, about 90, or about 95) polyethylene terephthalate.

In some embodiments, polyethylene can be the main polymer with 5 wt. % (or about 5 wt. %) polypropylene mixed in. In some embodiments, polyethylene may be the only polymer in the matrix. In some embodiments, polypropylene may be the only polymer in the matrix. In some embodiments, polyethylene terephthalate may be used alone, or with small amounts of other polymers, such as 10 wt. % polyethylene (or about 10 wt. %) and/or 2 wt. % polypropylene (or about 2 wt. %) in the matrix. Mixtures of two, three, or more polymers can be used to form the polymer matrix.

As mentioned, the polymer matrix can include reinforcements, such as fiber reinforcements or fibers, to form a composite materials. The fibers can be different polymer, wood materials, glass, natural fibers, and the particular fibers are not limiting. For example, the fibers could come from recycled carpet, such as polyethylene terephthalate carpet fiber, nylon carpet fiber, recycled tires, polypropylene carpet fiber, and/or the backing of carpet material. The fiber material can include jute, polypropylene, or polyethylene terephthalate, though the type of material is not limiting. Other fibers can be used as well, either in combination or instead of the previously listed material. For example, e-glass (alumino-borosilicate glass), wood fibers, switchgrass, natural fibers, or other typical materials used in fiber composites can be included. In some embodiments, if fibers are used they can be 10, 20, 30, 40, 50, 60, 70, or 80 (or about 10, about 20, about 30, about 40, about 50, about 60, about 70, or about 80) wt. % of the composite. In some embodiments, if fibers are used they can be greater than 10, 20, 30, 40, 50, 60, 70, or 80 (or about 10, about 20, about 30, about 40, about 50, about 60, about 70, or about 80) wt. % of the composite. In some embodiments, if fibers are used they can be less than 10, 20, 30, 40, 50, 60, 70, or 80 (or about 10, about 20, about 30, about 40, about 50, about 60, about 70, or about 80) wt. % of the composite.

Further, strengtheners can be incorporated into the composite to provide additional physical properties. As an example, graphene or graphene nano-platelets can be incorporated to provide additional strength. In some embodiments, clay nanoparticles can be added.

As an example of a composite that can be formed into pallet components, recycled high density polyethylene, such as from bottle caps, can be combined with nylon carpet as reinforcement. The carpet fibers can be chopped or in continuous fragments of extended lengths along the axis of a pallet board/blank.

### Methods of Manufacture

Certain polymers, such as polyethylene and polypropylene, may not mix easily. Accordingly, twin screw extrusion or static mixers can be used to encourage the polymers to form a mixture. This can form mixtures that may look like eutectic mixtures seen in metal alloys. The mixing difficulties can be a function of the percent of each polymer. For example, small amounts of polypropylene in polyethylene may not require substantially different processing steps as normal polymer processing, and so a single screw extrusion is sufficient. In some embodiments, mixing in lower molecular weight polymers can be useful to ease flow of polymers during processing. For example, low density PE can help the flow of high density PE.

In some embodiments, the materials may be prepared prior to any processing. For example, preparation, cleaning, cutting, and/or grinding of any fiber reinforcements may be done.

As mentioned, the composite material can be formed from recycled materials. Bottles can be collected and broken down into polypropylene and polyethylene components. These can then be used to form the polymer matrix. Further, recycled materials can be broken down into fibers to act as reinforcements within the polymer matrix.

The composite material can be formed in a number of ways, and the particular methodology is not limiting. For example, over-molding can be used. The fiber reinforcements can benefit from heating to a temperature close to the melting temperature of the polymer matrix in order to facilitate wetting of the fibers by the matrix, thereby forming a strong interface between the matrix and the fiber reinforcement.

In some embodiments, the fibers can be treated with plasma prior to forming the composite. The plasma treatment can improve adhesion of the fibers to the matrix, and can improve wetting characteristics. In some embodiments, the plasma treatment can be performed with nitrogen plasma, but other plasma can be used as well. In some embodiments, the fibers can be treated for 0.1, 0.5, 1, 2, 3, 5, 6, 7, 8, 9, or 10 (or about 0.1, about 0.5, about 1, about 2, about 3, about 4, about 5, about 6, about 7, about 8, about 9, or about 10) seconds. In some embodiments, the fibers can be treated for greater than 0.1, 0.5, 1, 2, 3, 5, 6, 7, 8, 9, or 10 (or about 0.1, about 0.5, about 1, about 2, about 3, about 4, about 5, about 6, about 7, about 8, about 9, or about 10) seconds. In some embodiments, the fibers can be treated for less than 0.1, 0.5, 1, 2, 3, 5, 6, 7, 8, 9, or 10 (or about 0.1, about 0.5, about 1, about 2, about 3, about 4, about 5, about 6, about 7, about 8, about 9, or about 10) seconds.

In some embodiments, voids are intentionally allowed to form in the matrix to reduce density. This can occur, for example, at the reinforcement fiber interface with the polymer (e.g., the reinforcement matrix interface). The voids can make up between 1 and 30% of the composite. For example, the voids can make up 1, 5, 10, 15, 20, 25, or 30% (or about 1, about 5, about 10, about 15, about 20, about 25, or about 30) of the composite. In some embodiments, the voids can make up greater than 1, 5, 10, 15, 20, 25, or 30% (or about 1, about 5, about 10, about 15, about 20, about 25, or about 30) of the composite. In some embodiments, the voids can make up less than 1, 5, 10, 15, 20, 25, or 30% (or about 1, about 5, about 10, about 15, about 20, about 25, or about 30) of the composite.

Compression molding can be used as well. Compression molding can allow for the formation of the voids to reduce density. Further, compression molding on a preheated reinforcement fiber can improve wetting, as mentioned above with over-molding.

Any of the different molding steps can form the particular pallet components, such as pallet boards. Molds can be used to form the particular shape/dimensions of the pallet boards. Other shapes and designs can be used as well, depending on the particular component. For example, the composite pallet components can be modeled after pallet boards. They can have a 11/16″ thickness with 40″×48″ dimensions.

In order to improve certain mechanical properties, the composite polymers can be formed into a spar or rib shape.

Once the composite components are made, they can be assembled into a pallet. In some embodiments, the composite polymer pallet components can be assembled into a pallet through the use of welding, such as ultrasonic welding. This would avoid the need for fasteners, such as nails and screws, and therefore there is a reduced chance of damage to forklift and truck tires from fasteners that fall loose. However, other construction methods can be used, and the listed method is not limiting. In some embodiments, fasteners can be used.

### Testing Methodology

Different types of pallet components were tested for their physical properties. This includes a Stringer pallet component, a Block pallet component, and a wood-plastic composite pallet.

### Compression Strength

A Highlight load cell was used to measure the maximum compression force of a pallet or pallet components. A Stringer pallet with 24 pack cases of water with a tier sheet after the second layer was used in this test. The load cell was aligned under the top deck board of the Stringer pallet and the software provided by Highlight Industries was used to control the load cell. Spacers were used to adjust the height of the load cell. The maximum compression force was measured for 10 minutes.

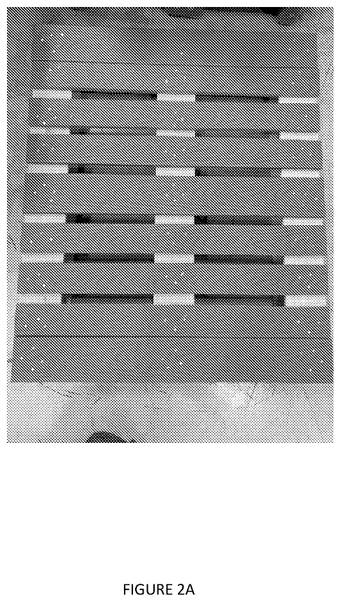

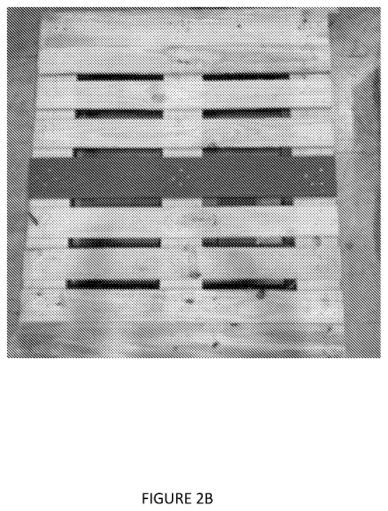

After the maximum force and deflection was measured on a top deck board of a Stringer pallet, the top deck boards were replaced with wood-plastic composite boards according to the disclosure and the maximum compression was measured using the load cell. The maximum force was measured on all the top deck boards and then they were replaced with the composite boards. FIG. 2A shows the top wood top deck boards replaced with the composite boards according to embodiments of the disclosure, while FIG. 2B illustrates a single top deck board replaced with a composite board.

### Maximum Deflection

A three point bend test was performed using the Lansmont compression table and the feel stiffness fixture. The three point bend test measures the maximum deflection in mm and maximum force in lbs. The top deck board was placed on the supporting pins and the feel stiffness fixture was used to apply downward force on the plank. Three top deck boards from the Stringer pallets were tested to account for any standard deviation in the properties of the wood. Similarly, three top deck boards from Block pallets and three composite boards according to the disclosure were tested. The yield on the compression table was set to 50%.

The maximum force and maximum deflection may be used to calculate the Modulus of Elasticity. The Modulus of Elasticity is a ratio of stress in the body to the corresponding strain. The Modulus of Elasticity can be used to compare the properties of the Stringer pallet, Block pallet and the composite board. The Modulus of Elasticity can be calculated by using the following formula:

$$Modulus of elasticity M O E = \frac{P \cdot {L}^{3}}{4 \cdot D \cdot w \cdot {h}^{3}} ( psi )$$

where P is the load applied at the center (maximum force), L is the length of the support span, D is the deflection at midspan (maximum deflection), w is the width of the beam, h is the thickness of the beam

### FTIR Analysis

A Thermo Fisher FTIR (Fourier transform infrared) was used for this test. When IR radiation is passed through a sample, some radiation is absorbed by the sample and some passes through (is transmitted). The resulting signal at the detector is a spectrum representing a molecular ‘fingerprint’ of the sample. The spectrum was obtained in the range of 4000 cm⁻¹ to 500 cm⁻¹.

### Results

### Compressive Strength

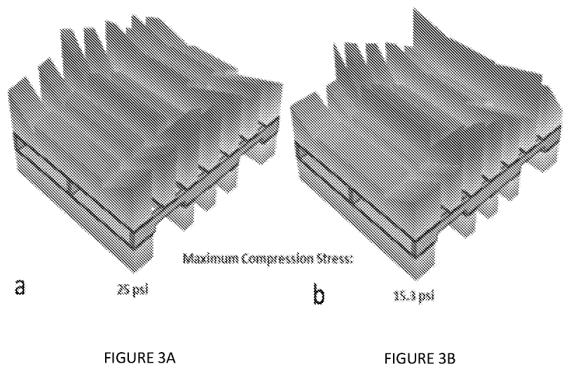

When the pallet was placed on the load cell, the maximum force immediately went up and then started to level off. It stayed almost constant for the entire duration of the test. The type of pallet used would result in a change in the maximum force. This change was due to the difference in the quality of wood. Another factor affecting the maximum force is the dimensions of the top deck board. There are variations in the width and thickness of the top deck boards due to the manufacturing process involved. The design of the pallet would also affect the maximum force applied. FIGS. 3A and 3B shows the difference in the maximum force on the outer top deck board where the first pallet has 3.5 inch top deck boards (FIG. 3A) and the second pallet has 5.5 inch top deck boards (FIG. 3B). The 3.5 inch top leaderboard pallet has a maximum force of 25 psi and the 5.5 inch top leaderboard pallet has a maximum force of 15.3 psi. This difference in width results in a difference of 9.7 psi of force.

After placing the load cell under the composite board and measuring, the maximum force on the composite board was similar to the maximum force on the Block pallet. When measuring the compression force on the top deck board for Stringer and Block pallets, the load cell was placed under the deck board 1. FIGS. 2A-2B shows the location of the top deck boards. Table 2 shows the maximum compression strength for the Stringer pallet and Block pallet. The maximum compression force was different for the Stringer pallet and Block pallet because of their design. FIG. 3A shows the design of the Stringer Pallet, which has a 3.5 inch top leaderboard compared to the 5.5 inch top leaderboard on the Block pallet (FIG. 3B). The difference in compression force could also have been because the Stringer pallets are made of different types of recycled wood compared to virgin hardwood used to make the Block pallets.

TABLE 2
Maximum Compression Force on different types of pallets

| Type of Pallet | Maximum Compression Force (lbs.) |
|---|---|
| Stringer | 151.7 |
| Block | 126.3 |

Table 3 shows the maximum compression force on each deck board. The compression force was measured on deck board 1 and then it was replaced with the composite board. This was repeated for top deck boards 2, 3, 4 and 5. The maximum compression force continues increasing as more wooden boards are replaced with the composite boards because of the increase in weight of the pallet. A standard Stringer pallet weighs 60 lbs and a Stringer pallet with all the deck boards replaced with composite boards weighs 90 lbs. A pallet scale was used to weigh a standard Stringer pallet and a pallet with all the deck boards replaced with composite wood. Table 4 shows the weight of the Stringer Pallet and the weight of the pallet after all the deck boards were replaced by composite boards.

TABLE 3
Maximum Compression Force on the Composite top deck boards

| Top Deck Board | Maximum Compression Force (lbs.) |
|---|---|
| Composite top Deck Board-1 | 106 |
| Composite top Deck Board-2 | 123 |
| Composite top Deck Board-3 | 148 |
| Composite top Deck Board-4 | 224 |
| Composite top Deck Board-5 | 255 |

TABLE 4
Weight of pallet

| Type of pallet | Weight of Pallet (lbs.) |
|---|---|
| Stringer Pallet | 60 |
| Stringer Pallet with composite deck boards | 90 |

### Maximum Deflection

Since the deck boards are made of different types of wood, it was useful to calculate the Modulus of Elasticity in order to compare the properties of the pallets. The Modulus of Elasticity accounts for the length, thickness, width, maximum deflection and maximum force. Table 5 shows the Maximum force (N), Maximum Deflection, thickness, width and the Modulus of Elasticity for Stringer pallets. The length of the top deck board is the same. There is a slight variation in the thickness and thickness of the deck boards due to the manufacturing process. The maximum force and maximum deflection could have been affected by the different thickness and width. The moisture content of the top deck boards could have also affected the maximum force and maximum deflection and the resulting Modulus of Elasticity.

TABLE 5
Modulus of Elasticity for Stringer pallets

| Stringer | | Maximum | Component | Component | Component | Modulus of |
|---|---|---|---|---|---|---|
| Pallet | Maximum | Deflection | Length L | Thickness h | Width w | Elasticity |
| Samples | Force (N) | D (mm) | (mm) | (mm) | (mm) | (MPa) |
| Sample-1 | 2673.38 | 22.524 | 571.5 | 14.732 | 85.85 | 20,178.02 |
| Sample-2 | 1957.21 | 14.27 | 571.5 | 12.7 | 83.82 | 37,277.21 |
| Sample-3 | 2885.75 | 25.72 | 571.5 | 12.7 | 83.82 | 30,494.23 |
| Average | 2505.45 ± | 20.84 ± | 571.50 ± 0.0 | 13.38 ± 0.96 | 84.50 ± 0.96 | 29316.49 ± |
| | 397.24 | 4.82 | | | | 7030.21 |

Table 6 shows the Modulus of Elasticity for the Block pallets. The top deck boards were tested using the 3 point bend test method to measure the maximum deflection and maximum force. These values were used to calculate the Modulus of Elasticity for the Block pallets. The Modulus of Elasticity was lower for the Block pallets because of lower maximum force and maximum deflection.

TABLE 6
Modulus of Elasticity for Block pallets

| Block | Maximum | Maximum | Component | Component | Component | Modulus of |
|---|---|---|---|---|---|---|
| Pallet | Force | Deflection D | Length L | Thickness h | Width w | Elasticity |
| Samples | (N) | (mm) | (mm) | (mm) | (mm) | (MPa) |
| Sample-1 | 2135.15 | 24.73 | 571.50 | 16.76 | 91.44 | 9353.91 |
| Sample-2 | 2019.49 | 19.75 | 571.50 | 16.51 | 88.90 | 11924.30 |
| Sample-3 | 1952.77 | 11.23 | 571.50 | 16.25 | 88.90 | 21277.18 |
| Average | 2035.80 ± 75.34 | 18.57 ± 5.57 | 571.50 ± 0.0 | 16.51 ± 0.21 | 89.75 ± 1.20 | 14185.13 ± 5123.45 |

Table 7 shows the Modulus of Elasticity of the composite board. The Modulus of Elasticity of the composite board is lower than the Stringer and Block pallets. This may be due to the manufacturing process and the use of recycled plastic.

TABLE 7
Modulus of Elasticity for Composite Board

| Composite | Maximum | Maximum | Component | Component | Component | Modulus of |
|---|---|---|---|---|---|---|
| Board | Force | Deflection D | Length L | Thickness h | Width w | Elasticity |
| Samples | (N) | (mm) | (mm) | (mm) | (mm) | (MPa) |
| Sample-1 | 1561.32 | 37.793 | 571.50 | 22.098 | 99.06 | 1,926.41 |
| Sample-2 | 1694.32 | 39.03 | 571.50 | 21.84 | 103.12 | 2,014.28 |
| Sample-3 | 1410.08 | 38.14 | 571.50 | 21.84 | 99.568 | 1,776.68 |
| Average | 1555.24 ± 116.12 | 38.321 ± 0.52 | 571.50 ± 0.0 | 21.926 ± 0.12 | 100.58 ± 1.81 | 1905.79 ± 98.09 |

### FTIR Analysis

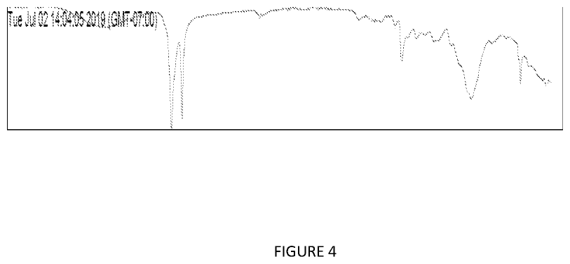

The sample spectrum was in the range of 4000 to 500 cm⁻¹. The sample spectrum was compared to the Thermo Fisher database and found to be most consistent with Polyethylene. FIG. 4 shows the results of the FTIR test.

Table 8 shows the FTIR peaks, their frequencies and identifications of the peaks and their functional groups. The FTIR peaks were compared to the IR frequency table to obtain the function group. The composite board was a combination of polyethylene and wood fibers due to the presence of the peak C—O stretch.

TABLE 8
Results from the FTIR analysis

| IR Frequency (cm⁻¹) | Functional Group |
|---|---|
| 2900, 2800 | CH₂ (stretch) |
| 1400 | CH₂ (bend) |
| 700 | CH₂ (rock) |
| 1100 | C-O (stretch) |

From the foregoing description, it will be appreciated that inventive pallet construction and methods of manufacture are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

1. A composite polymer deckboard component comprising:
a polymer matrix selected from the group consisting of polypropylene, polyethylene, polyethylene terephthalate, and combinations thereof;
wherein the composite polymer deckboard component is shaped to replace a wooden deckboard on a pallet.

2. The composite polymer deckboard component of claim 1, wherein the polymer matrix comprises only polypropylene.

3. The composite polymer deckboard component of claim 1, wherein the polymer matrix comprises only polyethylene.

4. The composite polymer deckboard component of claim 1, wherein the polymer matrix comprises only polyethylene terephthalate.

5. The composite polymer deckboard component of claim 1, further comprising graphene or graphene nano-platelets.

6. The composite polymer deckboard component of claim 1, wherein the polymer matrix comprises about 95% polyethylene with about 5% polypropylene.

7. The composite polymer deckboard component of claim 1, wherein the polymer matrix comprises about 10% polyethylene and/or about 2% polypropylene with the remainder being polyethylene terephthalate.

8. The composite polymer deckboard component of claim 1, further including a plurality of fibers embedded into the polymer matrix.

9. The composite polymer deckboard component of claim 8, wherein the plurality of fibers are selected from the group consisting of polyethylene terephthalate, polypropylene, jute, e-glass, wood, switchgrass, natural fibers and combinations thereof.

10. The composite polymer deckboard component of claim 8, wherein the plurality of fibers are plasma treated.

11-25. (canceled)

26. A pallet comprising:
a plurality of bottom boards extending in a first direction, each of the plurality of bottom boards having a first end, a middle, and a second end;
a plurality of top boards extending in the first direction, each of the plurality of top boards having a first end, a middle end, and a second end; and
a plurality of connecting boards extending in a second direction generally transverse to the first direction, a first of the plurality of connecting boards attaching the first ends of the plurality of bottom boards to the first ends of the plurality of top boards, a second of the plurality of connecting boards attaching the middles of the plurality of bottom boards to the middles of the plurality of top boards, and a third of the plurality of connecting boards attaching the second ends of the plurality of bottom boards to the second ends of the plurality of top boards;
wherein the plurality of top boards comprises a polymer matrix selected from the group consisting of polypropylene, polyethylene, polyethylene terephthalate, or combinations thereof.

27. The pallet of claim 26, wherein the polymer matrix comprises only polypropylene.

28. The pallet of claim 26, wherein the polymer matrix comprises only polyethylene.

29. The pallet of claim 26, wherein the polymer matrix comprises only polyethylene terephthalate.

30. The pallet of claim 26, further comprising graphene or graphene nano-platelets.

31. The pallet of claim 26, wherein the polymer matrix comprises about 95% polyethylene with about 5% polypropylene.

32. The pallet of claim 26, wherein the polymer matrix comprises about 10% polyethylene and/or about 2% polypropylene with the remainder being polyethylene terephthalate.

33. The pallet of claim 26, further including a plurality of fibers embedded into the polymer matrix.

34. The pallet of claim 33, wherein the plurality of fibers are selected from the group consisting of polyethylene terephthalate, polypropylene, jute, e-glass, wood, switchgrass, natural fibers and combinations thereof.

35. The pallet of claim 33, wherein the plurality of fibers are plasma treated.
